(19) United States
(12) Patent Application Publication
(10) Pub. No.: US 2017/0085154 A1
(43) Pub. Date: Mar. 23, 2017

(54) Power generator based on gravity movement

(71) Applicant: Maria Jasmila Perez, Melbourne, FL (US)

(72) Inventor: Maria Jasmila Perez, Melbourne, FL (US)

(21) Appl. No.: 14/857,744

(22) Filed: Sep. 17, 2015

(51) Int. Cl. H02K 7/18; F03G 3/00

(52) U.S. Cl. CPC H02K 7/1853; F03G 3/00

(57) ABSTRACT

I would like to patent an idea of a Power Generator based on Gravity Movement of falling balls (connected through a cord with a mechanical turbine) that is overcome by the elasticity of trampolines waiting to move back up the balls and repeat the process on a gain of movement by the elasticity. This movement is not perpetual but repeats itself until the movement is ended and a sensor (Powered by a solar cell) makes a mechanical arm put the weighting balls back on the up position ready to fall again.

Power Generator produced by the movement of a turbine (like Wind Turbine Power) designed for the purpose of falling and going up movement from balls that goes up and down when they touch a trampoline or any kind of equipment that send them back up through elasticity. When it is going down because of the weight (needed to be determined for optimization and magnitude of force), it will touch a trampoline that will make it go up again every time each ball touches the trampoline.

These balls will have a cord that has a pulley on top which will be connected by cables or cords to move a mechanical turbine to generate the power like Wind turbine Power. All these equipment will be contained on a box that will be isolated from the noise of the power generator.

The dimensions of the weights needs to be determined and the height where the balls are coming from have to be determined too also, as well as the turbine. It will be equipped with a gear box to speed up or level off the motor speed for voltage.

### SUMMARY

The amount of power needs to be determined as well as a portable generator for a house, since I still do not have a prototype but I would like to patent the idea of a power generator based on gravity by the movement of falling balls that weigh a determined weight to move turbines designed especially for the size of the generator. After the balls have stopped their movement, they will be picked up by a mechanical arm that has a solar panel that powers only this movement and puts them back on top to be ready to fall again. And other balls will be released by a sensor that will make them fall and move up with the trampoline and the process repeats itself.

1. An idea of a Power Generator based on Gravity Movements of falling weight balls that go up again by the action of elasticity by a trampoline on the bottom (and the process repeats itself until a mechanical arm takes them up again powered by a solar cell), and move a wind turbine (because the balls are hold by a cord with a pulley) designed for the specific amount of power generated to be determined.
